(19) United States
(12) Patent Application Publication
(10) Pub. No.: US 2001/0029344 A1
(43) Pub. Date: Oct. 11, 2001

(54) Back support

(76) Inventor: Patrick J. Blomberg, Belmont, MA (US)

Correspondence Address: JOHN J. GAGEL, Fish & Richardson P.C., 225 Franklin Street, Boston, MA, 02110-2804, US

(21) Appl. No.: 09/796,936

(22) Filed: Feb. 28, 2001

Related U.S. Application Data
(60) Provisional application No. 60/186,043, filed on Mar. 1, 2000.

(51) Int. Cl. A61H 7/00

(52) U.S. Cl. 601/148

(57) ABSTRACT

A back support system including a pad capable of providing both support and massage to an individual's mid and lower back is described. The pad includes a lordotic curve support cell and at least one lower or mid back inflatable cell. The pad is useful in many hospital settings including the cardiac catheterization laboratory.

This application claims the benefit of a previously filed Provisional Application No. 60/186,043, filed Mar. 1, 2000, the contents of which is incorporated in its entirety.

### BACKGROUND OF THE INVENTION

This invention relates to a back support pad for reducing back pain, particularly during cardiac catheterization.

Cardiac catheterization is used both for the diagnosis and treatment of coronary artery disease. It involves the insertion of wires and catheters into a peripheral artery, typically the femoral artery in the inguinal area, which are then advanced through the major blood vessels of the body until they reach the arteries of the heart. Once the catheters are in place, contrast dye is injected into the coronary arteries and radiographic pictures are taken. It is a relatively painless procedure which requires only the use of a local anesthetic at the insertion site. The procedure is invasive, however, and requires that patients remain relatively motionless in a flat, supine position during its' entire 1-2 hour duration as well as the first 6-8 hours of recovery time. Maintaining this position for up to 10 hours places a tremendous strain on the lower back muscles which can be extremely painful. The discomfort is often so severe that it can jeopardize a patient's ability to complete the procedure. As a result, many of these patients require treatment with powerful narcotics such as morphine. This class of medication has been associated with a number of serious side effects including hypotension and respiratory depression.

### SUMMARY

In one aspect, the invention features a back-support pad which reduces back stress in a subject, e.g., hospitalized patients who are restricted in their mobility such as patients undergoing cardiac catheterization. The pad uses a cell, e.g., an inflatable cell, to provide substantially constant support to the area of the lumbar spine, i.e., the lordotic curve, and at least one inflatable cell to provide constant and/or alternating pressure to the area of the thoracic spine. By placing the pad under a subject, and then inflating and deflating the inflatable cells, the tension caused by remaining in a fixed position is reduced. At the same time, motion of the area below the waist and above the neck is minimized.

Accordingly, in one aspect, the invention features a method of reducing back stress in a subject during a medical or surgical procedure, e.g., a cardiac catheterization procedure. The method includes: placing a pad which includes at least one cell for substantially constant support to the lordotic curve and a series of inflatable cells under the subject, and inflating and deflating the inflatable cells during the procedure to thereby reduce back stress in the subject. Preferably, the pad includes a cell for substantially constant support of the lordotic curve and a series of inflatable cells for massage or support. Preferably, the cells do not extend below the lordotic curve support cell or above the shoulder blades of the subject. In another aspect, the invention features the pad.

Embodiments may also include one or more of the following features. The pad fits on a standard catheterization table. The length and/or width of the pad is less than the length and/or width of a standard catheterization table such that the pad can fit unobtrusively on the table. For example, the pad can be of a length less than 275 centimeters which is the standard length of a catheterization table and/or the width of the pad can be less than 76 centimeters which is the standard width of a catheterization table. This feature can maximize functionality of the pad in the cardiac catheterization laboratory.

Embodiments may also include one or more of the following features. The pad further includes a pressurizing unit, e.g., an air compressor unit, and connecting tubing. Each of the cells of the pad is separately connected to the pressurizing unit, e.g., each of the cells has a separate connecting tube to connect it to the pressurizing unit. This allows each of the cells to be inflated and deflated independently of each other. The connecting tubing can insert into the side of the pad located on the patient's left side. The vast majority of cardiac catheterizations are performed with the physician standing on the patient's right side. Thus, by having the tubing on the patient's left side, the risk of the tubing being in the way of the physician performing the procedure is reduced.

Embodiments may also include one or more of the following features. The pad further includes a controller for controlling the inflation and deflation of the cells. A control panel allows for manual inflation and deflation of the cells or the cells can be inflated and deflated in a pre-programmed sequence. For example, the lordotic curve support cell can be an inflatable cell which is inflated at a time zero prior to the procedure. This cell can then remain inflated throughout the procedure. The remaining series of cells can then be inflated and deflated according to a selected program. For example, the program can include inflating the cell closest to the lordotic curve support cell at the same time as the lordotic curve support cell is inflated. This cell can then remain inflated for a set period of time and then deflate. As this cell deflates, the cell directly above it on the pad can inflate, hold for the set period of time and then deflate. This sequence can continue sequentially until the inflatable cell at the top of the pad and closest to the subject's shoulder blades is inflated and deflated. The program can then be repeated. The use of the controller in conjunction with the pad reduces the time the physician has to spend adjusting the inflation and deflation of the pad during the procedure. Instead, the physician only needs to select a program prior to the procedure and, if desired, switch the program during the procedure.

Embodiments may also include one or more of the following features. The controller or control panel can also include a “hold” and “resume” option. This allows for additional control over the movement of the patient's body by providing a means of temporarily suspending all inflation and deflation activity. When the “hold” option is selected on the controller or control panel, all air cells are held fixed in whatever position they were in at that moment. The operator can then resume the inflation and deflation sequence by selecting the “resume” option on the controller or control panel. This hold/resume option is beneficial for use of the pad in a cardiac catheterization laboratory where it is important to have the ability to keep patients motionless during specific points in the procedure.

Embodiments may also include one or more of the following features. All of the cells on the pad can be rapidly deflated. For example, the controller or control panel can have a “deflate” option or the pad itself can have a means for releasing air from the cells, e.g., a deflation plug or valve. Quick deflation of the pad can be important during cardiac catheterization where it is not uncommon for patients to become unstable and require cardiopulmonary resuscitation (CPR). Performing CPR correctly requires that the patient be lying on a firm surface to ensure effective chest compressions. The ability to rapidly deflate the cells can, therefore, prevent the pad from interfering with patient care during an emergency.

Embodiments may also include one or more of the following features. The pad has a series of inflatable cells in addition to the lordotic curve support cell. The number of inflatable cells can depend on the length of the subject from the shoulders to the hips. Preferably, the pad includes two, three or four inflatable cells in addition to the lordotic curve support cell. For example, two different cell arrangements may be able to accommodate different body types: a longer pad having three inflatable air cells and a shorter pad having only two inflatable cells. Although differing in length, the pads can otherwise be identical in design and function. Preferably, the cells are approximately one, two or three centimeters apart from each other on the pad regardless of the number of inflatable cells. By varying the number of cells, unintentional manipulation of the shoulders, neck, hip, waist, or legs can be avoided regardless of the patient's size.

Embodiments may also have one or more of the following advantages. The design of the pad addresses several needs which are particularly beneficial to cardiac catheterization. For example, because, in embodiments, the cells of the pad do not extend below the lordotic curve or above the shoulder blades, manipulation of the areas of the neck, hips, and legs is avoided. In addition, because the lordotic curve support cell provides substantially constant support, movement of the waist is also avoided. These are important features of the pad for its use during cardiac catheterization procedures. The catheters used in cardiac catheterization extend from the patient's heart, through the major vessels, to the groin area where they exit the body. The portion of the catheters remaining outside the body in the groin area are continuously manipulated by the physician to change the position of the catheters in the heart. Any movement of the patient's waist, hips, and legs, could change the position of the catheters in the heart and seriously compromise the safety of the procedure. Thus, by not having inflatable cells underlying the patient's hips, or legs, and by providing substantially constant support to the lordotic curve, this risk is reduced. In addition, the pad also avoids manipulation of the patient's shoulders and neck. This feature is beneficial during cardiac catheterization because of the use of radiographic cameras during the procedure. These cameras need to move closely to the patient's shoulders, neck, and head as they take x-ray pictures of the heart and movement of the patient's shoulders and neck could interfere with camera positioning. This is avoided by not having inflatable cells under the shoulders or neck of the patient.

Other features and advantages of the invention will be apparent from the following detailed description, figures and from the claims.

### DESCRIPTION OF THE DRAWINGS

FIG. 1 is a view of the top pad and the pressurizing unit from a vantage point above the pad. The pad is a longer sized pad containing four cells, the lordotic curve support cell (12) and three additional inflatable cells (9-11).

FIG. 2 is a view of a longer sized pad from side (7). In this depiction, all four cells are deflated. The pressurizing unit and connector tubing have been omitted.

FIG. 3 is the same view as shown in FIG. 2, but with all cells fully inflated. The pressurizing unit and connector tubing have been omitted.

FIG. 4 depicts the longer sized pad positioned beneath a patient with only the largest air chamber inflated to provide support of the lordotic curve. As opposed to the previous diagrams, this one is from the vantage point of side (4) of the pad. Again, the pressurizing unit and connector tubing have been omitted.

FIG. 5 shows a control panel for the pad which is located on the front side of the pressurizing unit.

FIG. 6 is a view of the top of the shorter sized pad and the pressurizing unit from a vantage point above the pad. The shorter pad has only three cells, the lordotic curve support cell (12) and two additional inflatable cells (10-11).

FIG. 7 is a view of a shorter sized pad from side (7). In this depiction, all three cells are deflated. The pressurizing unit and connector tubing have been omitted.

FIG. 8 is the same view as FIG. 7, but with all cells fully inflated. The pressurizing unit and connector tubing have been omitted.

FIG. 9 depicts the shorter sized pad positioned beneath a patient with only the largest air chamber inflated to provide support of the lordotic curve. This view is from the vantage point of side (4) of the pad. Again, the pressurizing unit and connector tubing have been omitted.

### DETAILED DESCRIPTION OF THE PREFERRED EMBODIMENT

Referring to FIG. 1, a back-support pad system for reducing back stress during a surgical procedure such as a cardiac catheterization procedure, includes: a pad (40) to be placed under the patient's back, a pressurizing unit (25), and connecting tubing (13, 14, 15, 16).

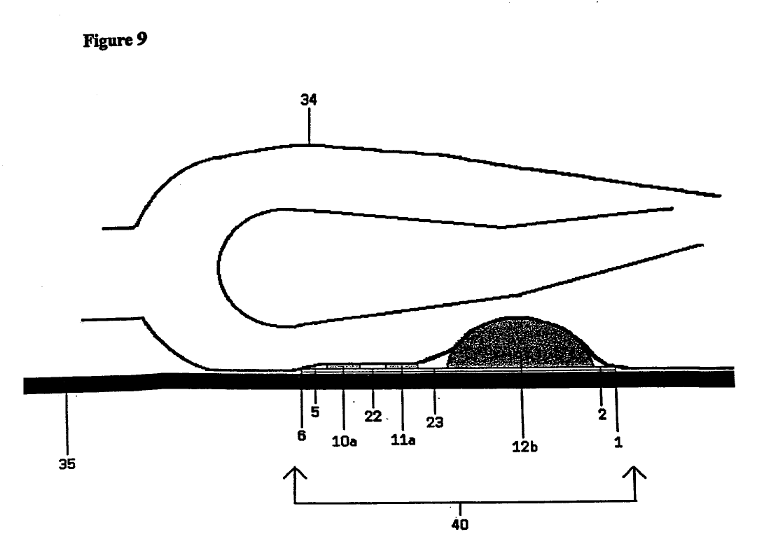

The back support pad includes a cell which provides substantially constant support to the lordotic curve and a series of inflatable cells. As shown in FIGS. 4 and 9, the inflatable cells (11, 10, 9) do not extend below the lordotic curve support cell (12) or above the shoulder blades. Preferably, the cells extend from the lower to mid-back. The area of “the lower and mid-back”, as used herein, refers to the lumbar and thoracic spine. For example, the cells can underlie any of the thoracic vertebrae from T5 to T12 as well as any of the lumbar vertebrae from L1 to L5. Preferably, the “lower back” does not include the vertebrae of the sacrum or coccyx and the “mid-back” does not include the cervical vertebrae or upper thoracic vertebrae.

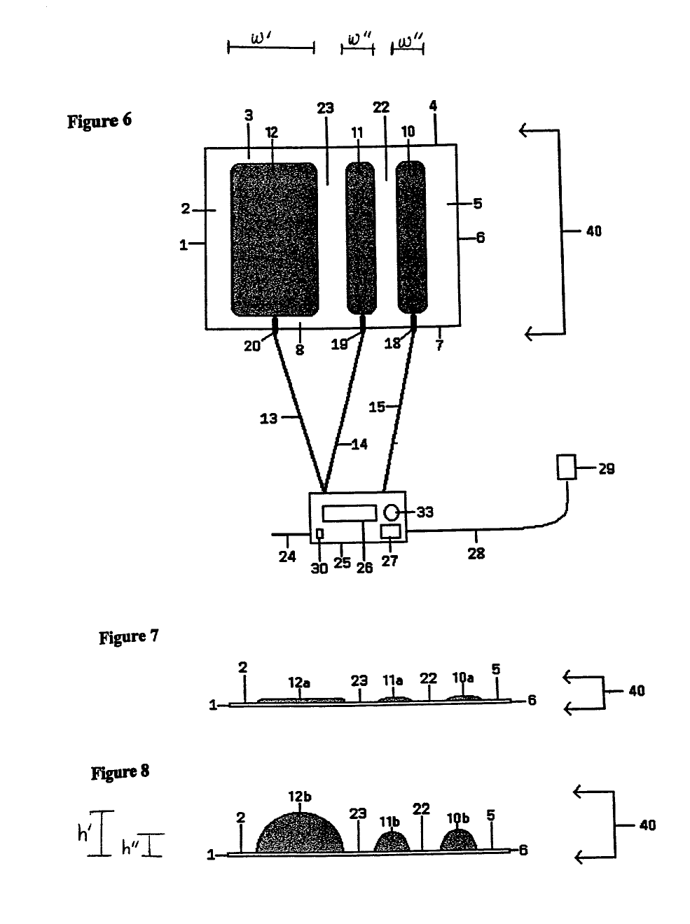

The lordotic curve support cell can be inflatable or non-inflatable. For example, the lordotic curve support cell can be a non-inflatable cushion, e.g., a solid plastic or foam cushion, or a stuffed cushion. Preferably, the lordotic curve support cell is an inflatable cell. The inflatable cell can be made of any type of material that can be inflated and deflated with minimal or no leakage through the material. In a preferred embodiment, the inflatable cell is made of plastic. In addition to the lordotic curve support cell, the pad includes one or more lower or mid-back inflatable cells. Preferably, the inflatable cells do not extend below the lordotic curve support cell or above the shoulder blades. These inflatable cells can also be made of any material capable of inflating and deflating with minimal or no leakage through the material. The cells can be inflated with a gas, e.g., air, or a liquid, e.g., water. Preferably, the cells are inflated with air. The number of inflatable cells can vary depending on the length of the patient from the shoulders to the hips. For example, in addition to the lordotic curve support cell, the pad can include 2, 3, 4, or 5 inflatable cells. Preferably, the pad has one of two cell arrangements: a longer pad which includes three inflatable cells and a lordotic curve support cell as shown in FIGS. 1-4, or a shorter pad which includes two inflatable cells and a lordotic curve support cell as shown in FIGS. 6-9.

Referring to FIGS. 1-4, the longer pad includes a lordotic curve support cell (12) and three inflatable cells (9, 10, 11) arranged in a parallel manner. As shown in FIGS. 6-9, the shorter pad includes a lordotic curve support cell (12) and two inflatable cells (10, 11) arranged in a parallel manner. Preferably, the lordotic curve support cell (12) has a width (w′) that is greater than the width (w″) of the lower or mid-back inflatable cells (9, 10, 11) and the lower or mid-back inflatable cells are the same width (w″) as each other. For example, the lordotic curve support cell can be between about 10 to 15 centimeters wide, preferably the lordotic curve support cell is approximately 12 centimeters wide. Each of the inflatable cells can be between about 5 and 10 centimeters wide, preferably each of the inflatable cells is approximately 7 centimeters wide.

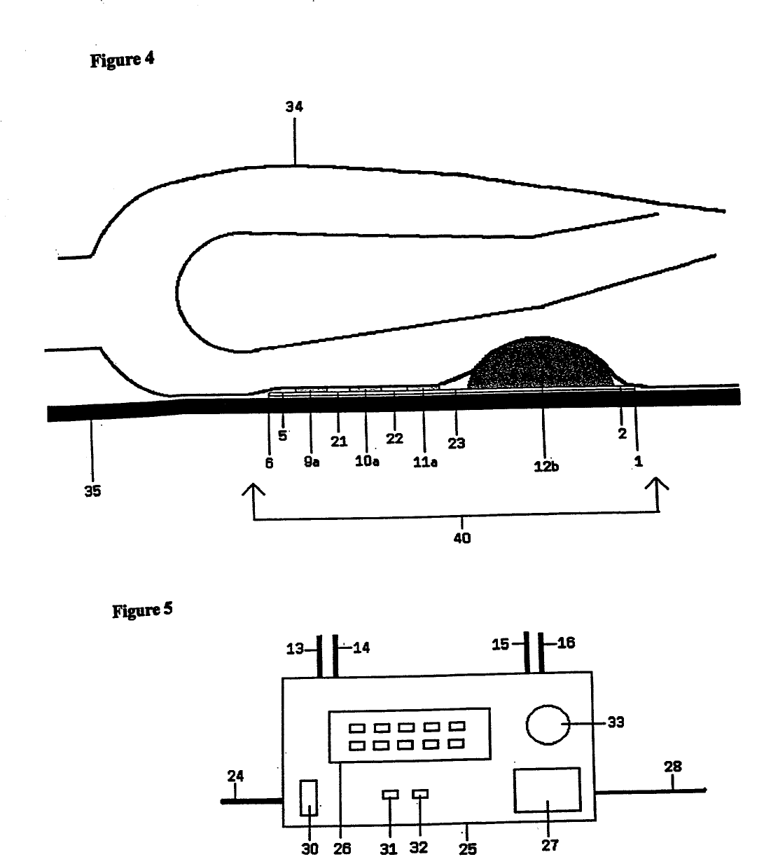

FIGS. 3 and 8 show a pad with all of the cells inflated. Preferably, all of the cells have a dome shape when they are inflated. However, the cell can have other shapes, e.g., rectangular. As shown in FIGS. 3 and 8, the lordotic support cell (12b) preferably has a height (h′) when inflated that is greater than the height (h″) of the lower or mid-back inflatable cells (9b, 10b, 11b) when they are inflated. Each of the lower or mid-back inflatable cells can be the same height (h″) when inflated as the others. For example, the lordotic curve support cell can be between about 6 to 8 centimeters, preferably approximately 7 centimeters, high when the cell is inflated. Each of the inflatable cells can be between about 3 to 5 centimeters high, preferably approximately 4 centimeters high, when inflated.

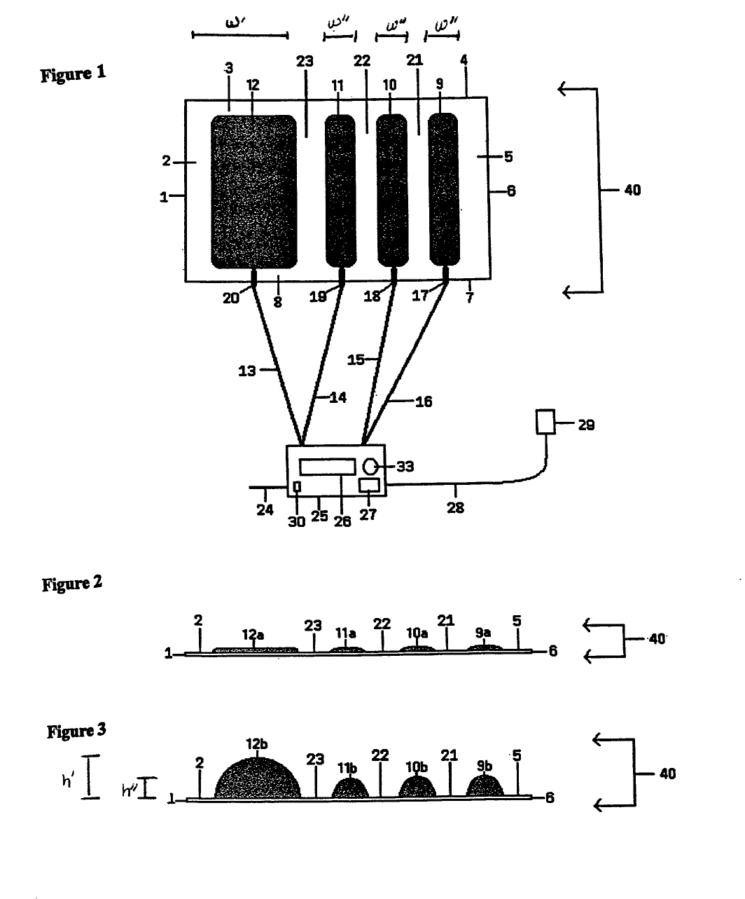

As shown in FIGS. 2 and 7, all of the cells (12a, 11a, 10a, 9a) are flat when deflated.

The pad itself is flat and has dimensions less than the dimensions of a table or bed that it will rest on. Preferably, the dimensions of the pad are less than the dimensions of a standard catheterization table. A standard catheterization table is approximately 275 centimeters in length and approximately 76 centimeters wide. Thus, the pad can be of a length less than 275 centimeters and a width of less than 76 centimeters. Preferably, the pad is between about 30 to 45 centimeters in length. For example, the shorter pad can be between about 30 to 35 centimeters, preferably approximately 33 centimeters, in length and the longer pad can be between about 35 to 45 centimeters, preferably 40 centimeters, in length. The shorter and longer pads can also be of the same length. The width of the pad is preferably between about 30 to 35 centimeters wide, e.g., approximately 32 centimeters wide.

The longer pad is shown in FIG. 1 and the shorter pad is shown in FIG. 6. As shown in FIGS. 1 and 6, side (1) of the pad is perpendicular to the long axis of the patient's body and is closest to the patient's feet. Side (6) is also perpendicular to the patient's long axis but is closer to the patient's head. Sides (1) and (6) are referred to above with regards to the “width” of the pad. Side (4) of the pad is the side of the pad that runs parallel to the patient's right side and side (7) runs parallel to the patients left side. Sides (4) and (7) are referred to above with regards to the “length” of the pad.

The area of the pad around surrounding the cells is preferably made of a stiff material such as a stiff plastic. The areas of the pad surrounding the cells are preferably flat and noninflatable. For example, as shown in FIGS. 1-3 and 6-8, space (2) between side (1) to lordotic curve support cell (12); space (23) between lordotic support cell (12) to cell (11); space (22) between cell (11) and cell (10); space (21) between cell (10) and cell (9); and space (5) between cell (9) and side (6) are all flat and non-inflatable. In addition, area (3) between side (4) and the cells (12, 11, 10, 9) and area (8) between side (7) and the cells (12, 11, 10, 9) is also flat and non-inflatable. Preferably, each cell (12, 11, 10, 9) is separated from the next cell by about one, two or three centimeters, e.g., each of spaces (23, 22,21) is approximately two centimeters. The areas (2 and 5) between sides (1 and 6, respectively) and cells (12 and 10/9, respectively) are preferably about 1 to 5 centimeters, e.g., approximately 2 centimeters, by approximately 30-35 centimeters, e.g., 2 centimeters (i.e., the width of sides (1 and 6) of the pad). The areas (3 and 8) between sides (4 and 7, respectively) and the cells can be about 1 to 5 centimeters, e.g., preferably approximately 1 centimeter, times the length of the pad (i.e., the length of sides (4 and 7)).

The pressurizing unit (25) is used to inflate and/or deflate the cells of the pad. An example of a pressurizing unit is an air compressor unit. The cells are connected to the pressurizing unit via connecting tubing. The connecting tubing is preferably made of a flexible material such as plastic. Preferably, each of the inflatable cells and the lordotic curve support cell are separately connected to the pressurizing unit. For example, as shown in FIG. 1, connecting tubes (13, 14, 15, 16) connect to cells (12, 11, 10, 9), respectively. This allows the cells to be inflated and/or deflated independently of each other. A connecting tube can be attached to the cell by, for example, a connector (20, 19, 18, 17).

By having the cells separately connected to the pressurizing unit, the lordotic curve support cell can be inflated, e.g., prior to the procedure, and can remain inflated throughout the procedure. In addition, the series of inflating cells can provide alternating or constant pressure to the patient's thoracic spine. Thus, the series of inflatable cells can be used for constant support and/or for massage and changes in the position of and tension on the muscles of the mid and lower back during the procedure. The pressure in the cells can also varied to apply differing amounts of pressure as a function of time.

The pad can further include a control for the pressurizing unit to control the inflation and deflation and pressure of the cells. As shown in FIG. 1, the controller is operated through a control panel (26) which can be part of the pressurizing unit (25). Alternatively, the controller can also be separate from the pressurizing unit. For example, the controller can be a computer which provides inflation and deflation information to the pressurizing unit or the controller can be a foot petal connected to the pressurizing unit for inflating and deflating the cells. The controller can allow for manual inflation and deflation of the cells or the cells can be inflated and deflated in a pre-programmed sequence. Various pre-programmed inflation sequences are available to the operator. For example, the lordotic curve support cell can be an inflatable cell which is inflated at a time zero prior to the procedure. This cell can then remain inflated throughout the procedure. The remaining series of cells can then be inflated and deflated according to a selected program. For example, the program can include inflating the cell closest to the lordotic curve support cell at the same time as the lordotic curve support cell is inflated. This cell can then remain inflated for a set period of time and then deflate. The period of time can vary. As this cell deflates, the cell directly above it on the pad can inflate, hold for the set period of time, and then deflate. This sequence can continue sequentially until the inflatable cell at the top of the pad and closest to the subject's shoulder blades is inflated and deflated. The program can then be repeated. Another program may inflate the lordotic curve support cell at a time zero prior to the procedure. Then after a set period of time the cell closest to the lordotic curve support cell can inflate, hold for a set period of time, and then deflate. Once that cell deflates, the cell directly above it can inflate, hold for the set period of time, and then deflate, and so on until the cell at the top of the pad and closest to the patient's head has deflated. At that time, the sequence can be repeated. Other variations in the program can exist. For example, a cell need not be completely deflated before the cell next to it begins to inflate, the sequence can begin at the cell at the top of the pad and closest to the patient's head, or two or more cells can be inflated and/or deflated at the same time.

Two examples of pre-programmed inflation sequences are described below. The first sequence begins at time zero with inflation of the lordotic curve support cell (12 in FIG. 1). This cell remains inflated in a fixed position during the entire sequence. At the three-minute mark, the cell immediately adjacent to the lordotic curve support cell inflates (11 in FIG. 1). This cell remains inflated for three minutes and then deflates. At the six-minute mark, the next adjacent cell inflates (10 in FIG. 1). It remains inflated for three minutes and then deflates. At the nine-minute mark, the third cell inflates and remains inflated for three minutes and then deflates (9 in FIG. 1). After twelve minutes, the sequence ends and then repeats itself. The lordotic curve support cell does not deflate at anytime during the sequence. This provides support of the area of the lumbar spine and simultaneous massage of the area of the area of the thoracic spine. For the shorter pad, this sequence can differ in that it can be a nine-minute sequence instead of twelve minutes as there is one less pad involved in the sequence.

The second pre-programmed sequence begins at time zero with inflation of the small cell immediately adjacent to the lordotic curve support cell (11 in FIG. 1). This cell remains inflated for three minutes and then deflates. At the three-minute mark, the next adjacent cell inflates (10 in FIG. 1). It remains inflated for three minutes and then deflates. At the six-minute mark, the third cell inflates (9 in FIG. 1). It remains inflated for three minutes and then deflates. After nine minutes, the sequence ends and then repeats itself. The lordotic curve support cell can remain deflated throughout the entire sequence (12 in FIG. 1) in order to massage the area of the thoracic spine without supporting the area of the lumbar spine or the lordotic curve support cell can remain inflated throughout the entire sequence (12 in FIG. 1) in order to support of the area of the lumbar spine and simultaneous massage of the area of the area of the thoracic spine. This sequence differs for the shorter pad in that the sequence can be a six-minute sequence instead of a nine-minute sequence as there is one less pad involved in the sequence.

In addition to massaging the back by having the cells alternatively inflating and deflating in a pre-programmed sequence, a manual mode can be selected such that any combination of cells remain inflated or deflated in a fixed pattern. This allows the pad to provide constant support to selected areas of the mid and lower back without massage. For example, only the lordotic curve support cell can be inflated to provide constant support to the lumbar spine as depicted in FIG. 4. This cell remains inflated in a fixed position until another selection is made.

In addition, the amount of air pressure used to inflate the cells can be controlled. For example, as shown in FIG. 5, the inflation pressure can be controlled by a dial (33). The amount of air pressure directly determines the firmness of the inflated air cells. The exact amount of pressure needed to achieve a specific firmness depends on several variables including the weight of the patient and the material used to form the cells. The inflation pressure can be separately controlled for each cell.

The control panel can also include a “hold” and “resume” option. As shown in FIG. 5, the hold (31) and resume controls (32) are part of the pressurizing unit. The hold/resume option can also be present on the pad or on a control panel which is not part of the pressurizing unit. The hold/resume option provides for additional control over the movement of the patient's body by providing a means of temporarily suspending all inflation and deflation activity. When the “hold” option is selected on the control panel, all air cells are held fixed in whatever position they were in at that moment. The inflation and deflation sequence can be restarted by selecting the “resume” option on the control panel.

In another embodiment, all of the cells on the pad can be rapidly deflated. The control panel can have a “deflate” option or the pad itself can have a means for releasing air from the cells, e.g., a deflation plug or valve. For example, button (27), as shown in FIG. 5, can be pressed in an emergency to rapidly decompress the air cells.

The pad can also include a control panel which can be patient controlled. For example, the pad can include two control panels, one for the physician to operate and the other for the patient to operate or the pad can include only one control panel, e.g., a hand-help control panel, which the physician and patient can alternate control. The patient control panel may allow for controlling pressure in all of the cells including the lordotic curve support cell or it may only allow for control of the inflatable cells other than the lordotic curve support cell. As shown FIGS. 1 and 6, the patient control panel (29) can be connected to the pressurizing unit by cord (28).

As shown in FIG. 1, the pressurizing unit (25) and the control panel (26) also has an electric cord and plug (24) to provide power to the unit. An on/off switch (30) can also be present on the pressurizing unit.

In another embodiment, each of the inflatable cells can be divided along its width into sub-cells. These sub-cells allow for support and/or massage in each cell which can be alternated between the subject's left and right sides.

Preferably, the cells do not extend below the lordotic curve support cell or above the shoulder blades. Although in embodiments, the pad could include cells extending into these regions. For example, the pad can include cells in this region which are non-inflatable or are operated to provide motionlessness during points in the procedure.

Other embodiments are within the following claims.

What is claimed:

1. A back support pad comprising:
a cell which provides substantially constant support to the lordotic curve; and
at least one lower or mid-back inflatable cell,
wherein the at least one inflatable cell extends only above the lordotic curve and below the shoulder blades.

2. The pad of claim 1, wherein the lordotic curve support cell is an inflatable cell.

3. The pad of claim 1, having two to four lower to mid-back inflatable cells.

4. The pad of claim 1, wherein the lordotic curve support cell has a height which is greater than the height of an inflatable cell.

5. The pad of claim 1, wherein the lordotic curve support cell has a width which is greater than the length of an inflatable cell.

6. The pad of claim 4, wherein all of the inflatable cells are inflatable to substantially the same maximum height.

7. The pad of claim 5, wherein all of the inflatable cells are substantially the same width.

8. The pad of claim 2, further comprising a pressurizing unit.

9. The pad of claim 8, wherein the inflatable cells and the lordotic support cell are separately connected to the pressurizing unit.

10. The pad of claim 9, wherein each of the cells can be inflated or deflated independently of each other.

11. The pad of claim 1, wherein the cells extend from the lordotic curve to the mid-back.

12. The pad of claim 10, wherein the inflatable cells sequentially inflate and deflate.

13. The pad of claim 1, wherein the length and width of the pad are sized to fit on a catherization table.

14. A method of reducing back stress in a subject during a medical or surgical procedure, comprising:
placing a pad under the subject, wherein the pad comprises a cell for substantially constant support of the lordotic curve and at least one lower or mid-back inflatable cell which extends only above the lordotic curve cell and below the shoulder blades of the subject;
inflating and deflating the inflatable cells, to thereby reduce back stress during the procedure.

15. The method of claim 14, wherein the cells underlie the thoracic and lumbar spine.

16. The method of claim 14, wherein the cell for lordotic curve support is inflatable and it is inflated prior to the procedure.

17. The method of claim 16, wherein at least two of the inflatable cells are inflated at the same time.

18. The method of claim 17, wherein all of the inflatable cells are inflated at the same time.

19. The method of claim 14, wherein the inflatable cells are inflated and deflated independently of each other.

20. The method of claim 19, wherein the inflatable cells are sequentially inflated a nd deflated.

21. The method of claim 20, wherein the sequential inflation and deflation is repeated.
